(19) United States
(12) Patent Application Publication
(10) Pub. No.: US 2017/0038923 A1
(43) Pub. Date: Feb. 9, 2017

(54) INFORMATION PROCESSING APPARATUS, DISPLAY CONTROL METHOD, AND PROGRAM

(71) Applicant: CANON KABUSHIKI KAISHA, Tokyo (JP)

(72) Inventor: Takashi Tsuzuki, Yokohama-shi (JP)

(21) Appl. No.: 15/226,648

(22) Filed: Aug. 2, 2016

(30) Foreign Application Priority Data
Aug. 7, 2015 (JP) 2015-157608

(51) Int. Cl. G06F 3/0482; H04N 1/00

(52) U.S. Cl. CPC G06F 3/0482; H04N 1/00307; H04N 2201/0094; H04N 2201/0041; H04N 2201/006

(57) ABSTRACT

An information processing apparatus includes a reception unit that receives a signal transmitted from an external apparatus, a specifying unit that specifies a distance from the external apparatus based on the received signal, a display control unit that controls displaying a selection screen for selecting the external apparatus, and a transmission unit that transmits data to the selected external apparatus. If the reception unit receives the signals from a plurality of external apparatuses, the external apparatuses are displayed in order of the distance based on the specified distance. If the reception unit receives the signal of a first external apparatus having an error occurring therein and the signal of a second external apparatus located farther away from the information processing apparatus than the first external apparatus and having no error occurring therein, the second external apparatus is displayed in priority to the first external apparatus.

### BACKGROUND OF THE INVENTION

Field

Aspects of the present invention generally relate to an information processing apparatus including near field wireless communication, a display control method therefor, and a program.

Description of the Related Art

When printing is carried out under an environment with a plurality of printing apparatuses in a surrounding area, a user typically checks respective characteristics of the printing apparatuses to determine and select the optimum printing apparatus from among them. As the total number of printing apparatuses and the number of types of printing apparatuses increase, it is becoming more difficult for the user to select the optimum printing apparatus optimum for the user's own print condition. To solve this issue, a method has been proposed where a server centrally manages information about the printing apparatuses and selects a printing apparatus most appropriate to the print condition (refer to Japanese Patent Application Laid-Open No. 2003-330669).

However, the method proposed in Japanese Patent Application Laid-Open No. 2003-330669 requires the registered information about the printing apparatuses in the server to be updated when the number of printing apparatuses that the server manages increases or decreases due to addition of or removal of a printing apparatus. This leads to an increase in a load imposed on a server administrator. Further, if the server administrator forgets to update the registered information about the printing apparatuses, inconsistency occurs between an actual situation under which the printing apparatuses are set up and the registered information about the printing apparatuses in the server. This can result in the user inadvertently selecting a non-existent printing apparatus.

### SUMMARY

According to an aspect of the present invention, an information processing apparatus includes a reception unit configured to receive a signal transmitted from an external apparatus, a specifying unit configured to specify a distance from the external apparatus based on the signal received by the reception unit, a display control unit configured to cause a display unit to display a selection screen for selecting the external apparatus based on the signal received by the reception unit, and a transmission unit configured to transmit data to the external apparatus selected on the selection screen. If the reception unit receives the signals from a plurality of external apparatuses, the display control unit causes the display unit to display the external apparatuses in order of the distance on the selection screen based on the distance specified by the specifying unit. If the reception unit receives the signal of a first external apparatus having an error occurring therein and the signal of a second external apparatus located farther away from the information processing apparatus than the first external apparatus and having no error occurring therein, the display control unit causes the display unit to display the second external apparatus in priority to the first external apparatus.

Further features of aspects of the present invention will become apparent from the following description of exemplary embodiments with reference to the attached drawings.

### BRIEF DESCRIPTION OF THE DRAWINGS

### Brief Description of Drawings

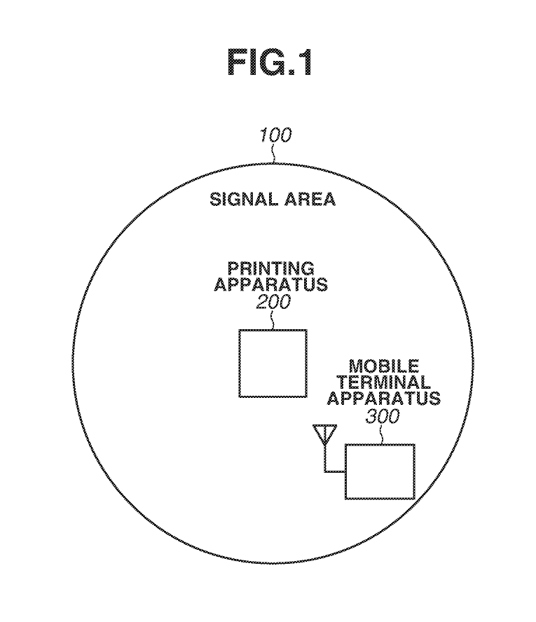

FIG. 1 is a schematic view illustrating a printing apparatus and a mobile terminal apparatus.

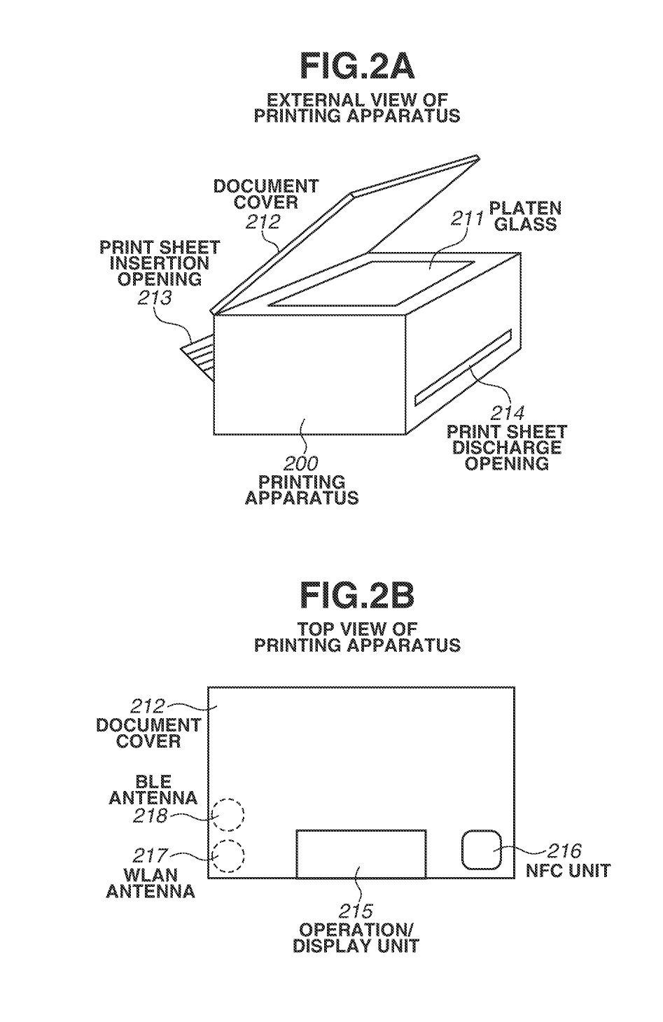

FIGS. 2A and 2B each illustrate an external view of the printing apparatus according to a first exemplary embodiment.

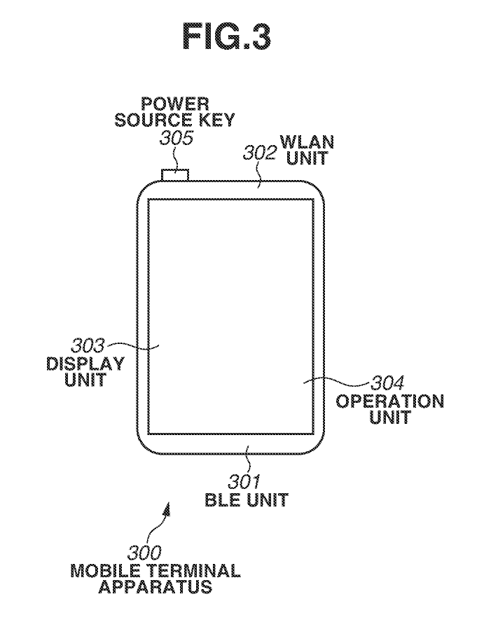

FIG. 3 illustrates an external view of the mobile terminal apparatus according to the first exemplary embodiment.

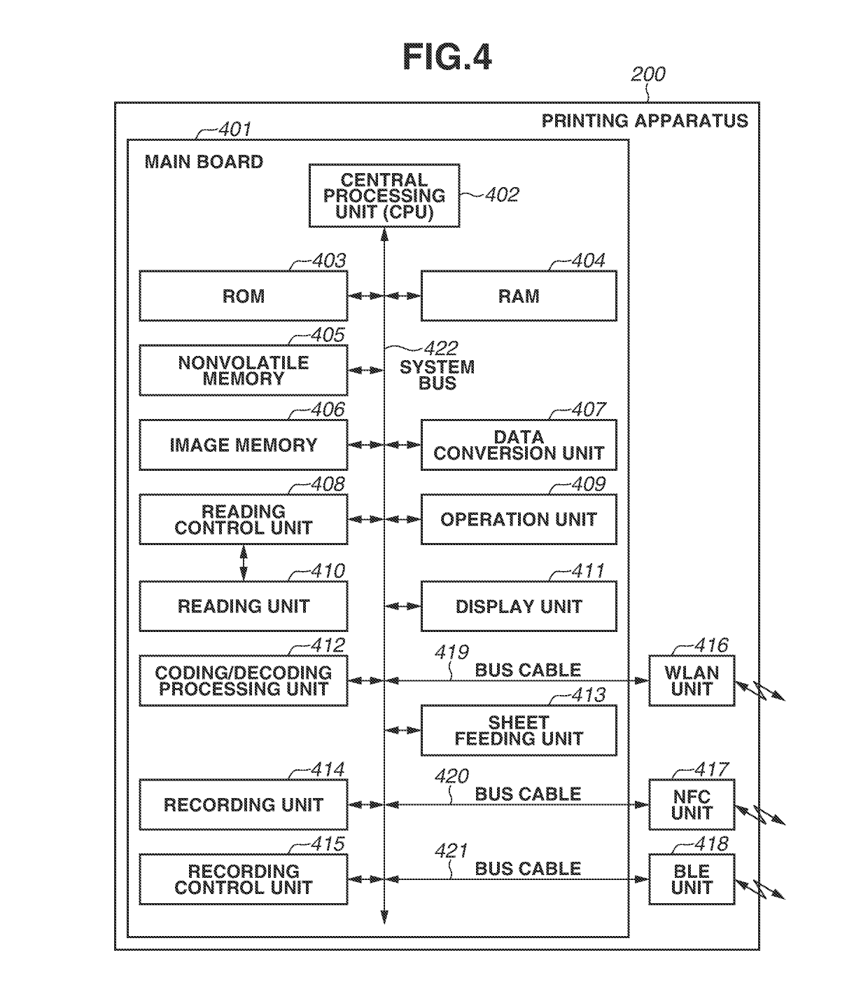

FIG. 4 is a block diagram illustrating an outline of a configuration of the printing apparatus according to the first exemplary embodiment.

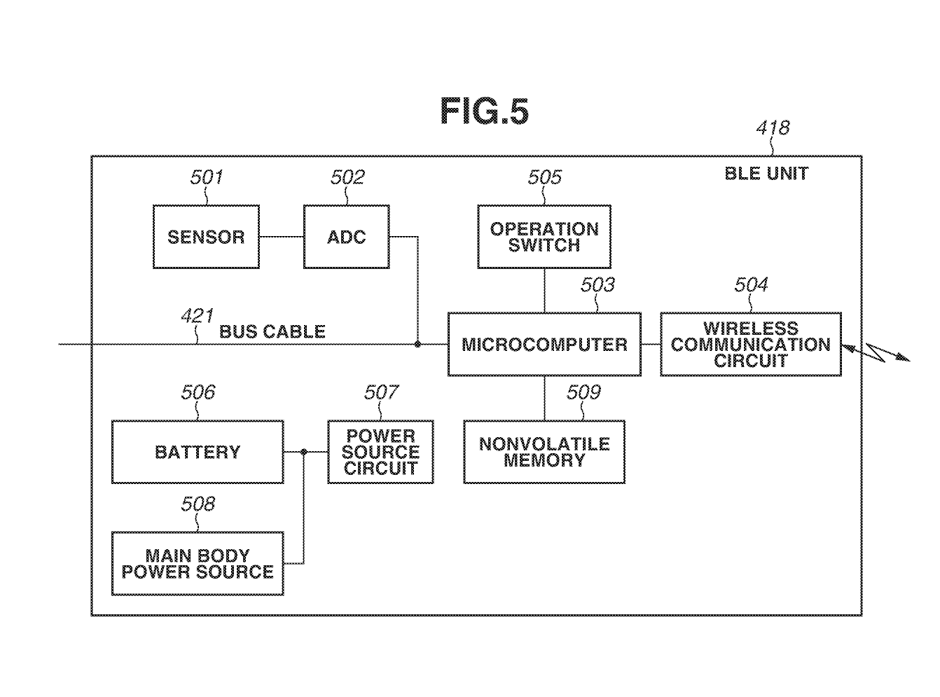

FIG. 5 is a block diagram illustrating an outline of a configuration of a Bluetooth Low Energy (BLE) unit according to the first exemplary embodiment.

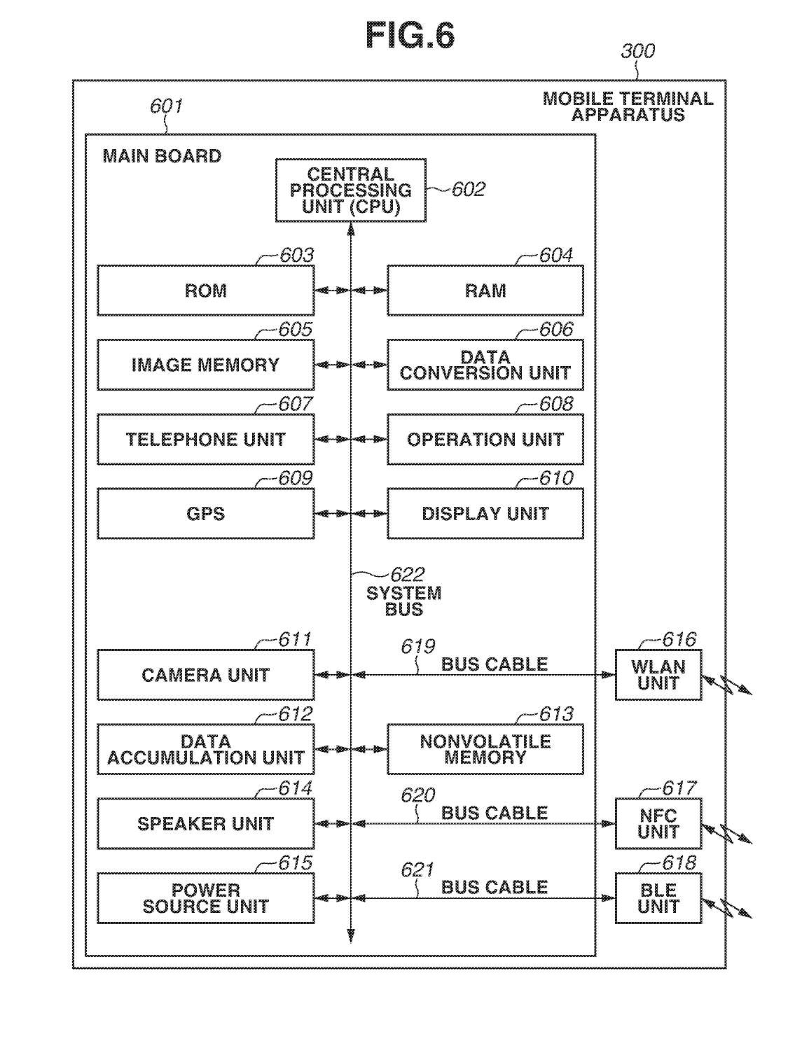

FIG. 6 illustrates a block diagram of the mobile terminal apparatus according to the first exemplary embodiment.

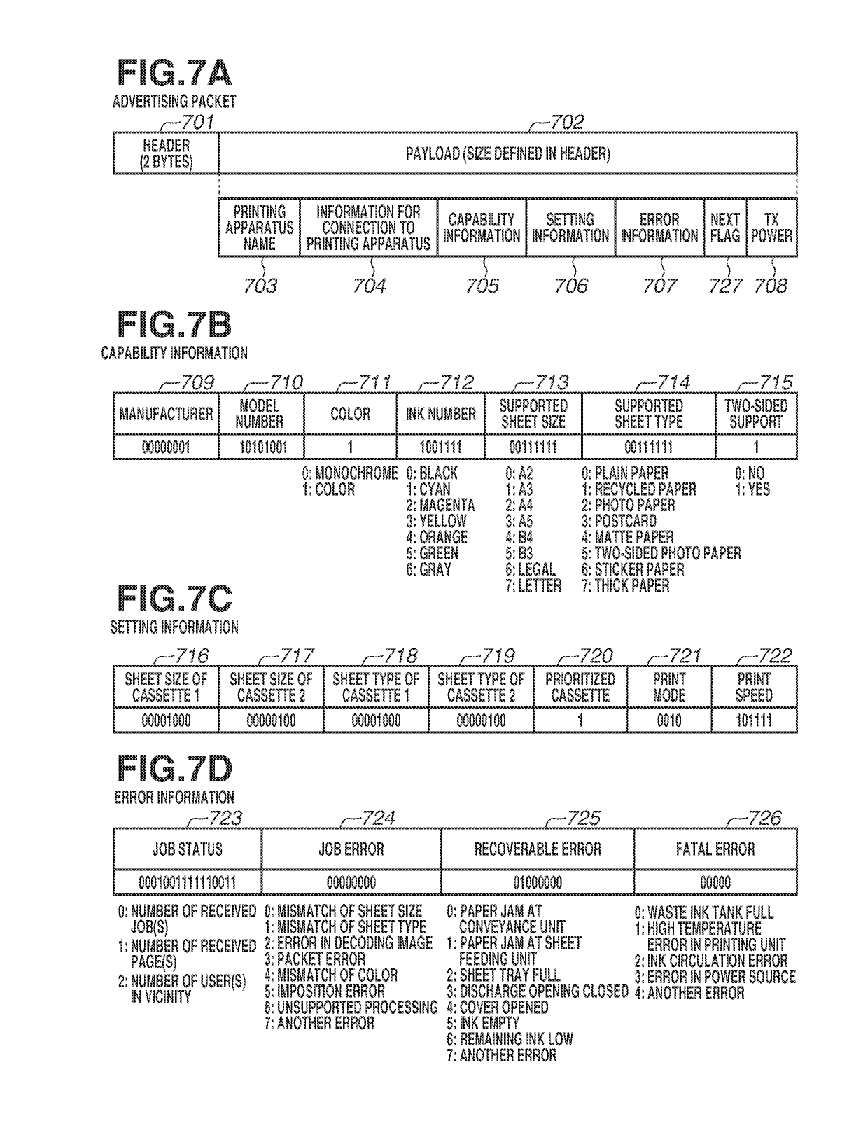

FIGS. 7A to 7D illustrate an advertising packet issued from the printing apparatus according to the first exemplary embodiment.

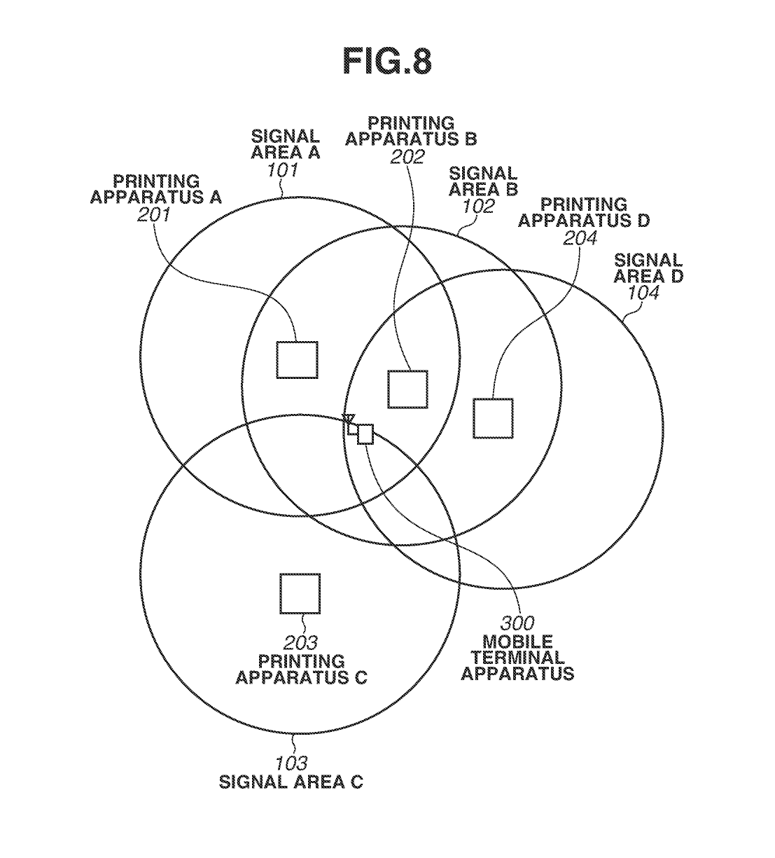

FIG. 8 is a schematic view illustrating a relationship between each of a plurality of printing apparatuses and the mobile terminal apparatus according to the first exemplary embodiment.

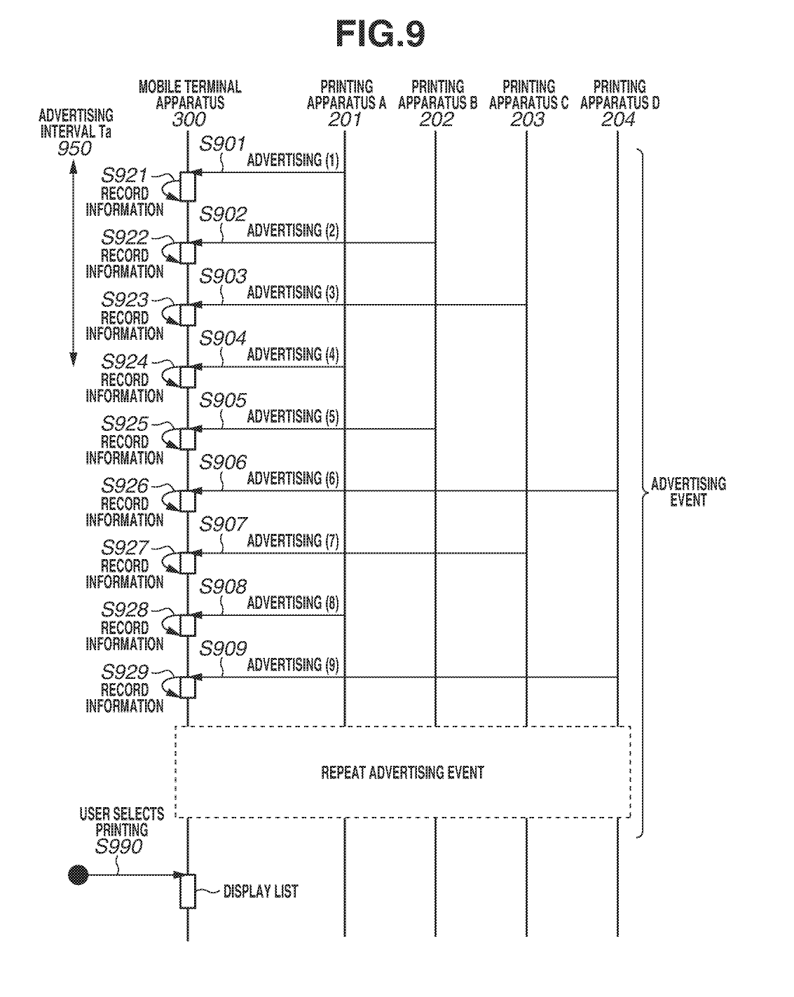

FIG. 9 is a sequence diagram illustrating a sequence of the plurality of printing apparatuses and the mobile terminal apparatus according to the first exemplary embodiment.

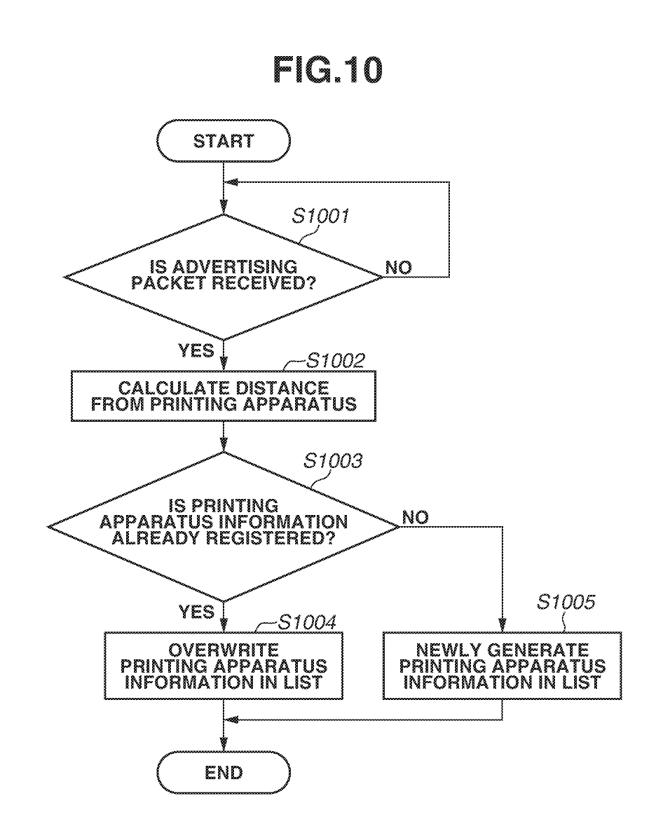

FIG. 10 is a flowchart illustrating processing performed by the mobile terminal apparatus according to the first exemplary embodiment.

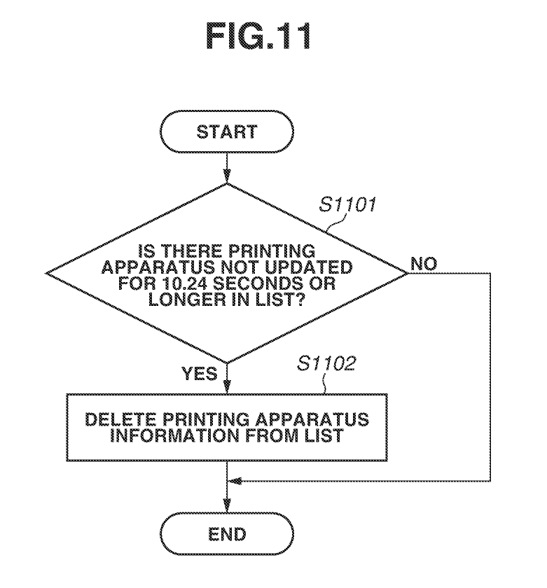

FIG. 11 is a flowchart illustrating processing performed by the mobile terminal apparatus according to the first exemplary embodiment.

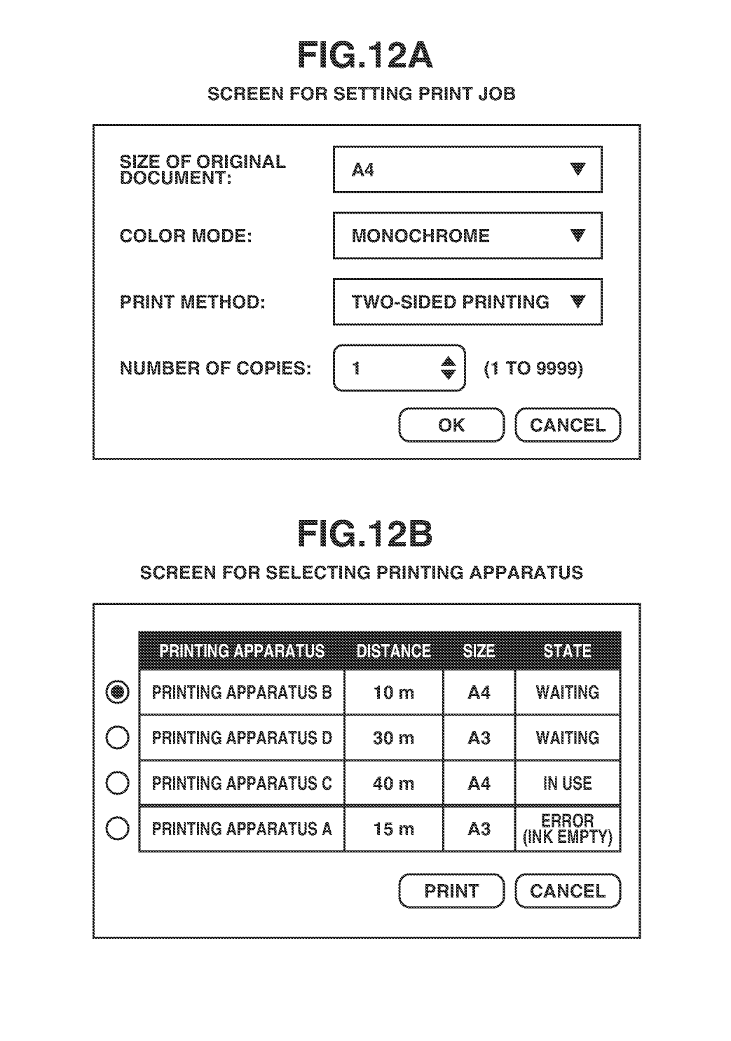

FIGS. 12A and 12B each illustrate one example of a display unit of the mobile terminal apparatus according to the first exemplary embodiment.

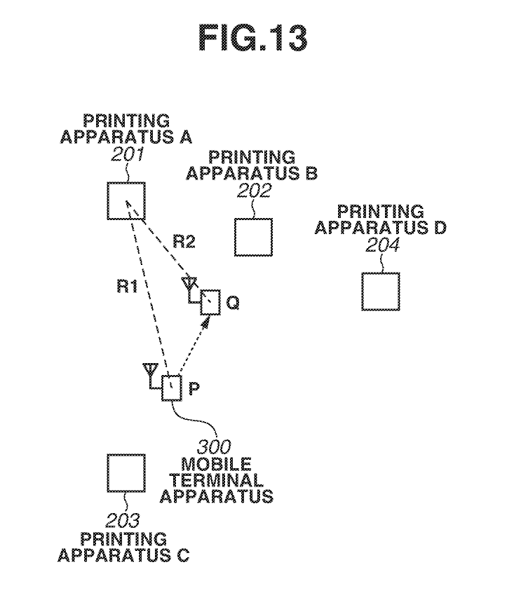

FIG. 13 is a schematic view illustrating a relationship between each of the plurality of printing apparatuses and the mobile terminal apparatus according to a second exemplary embodiment.

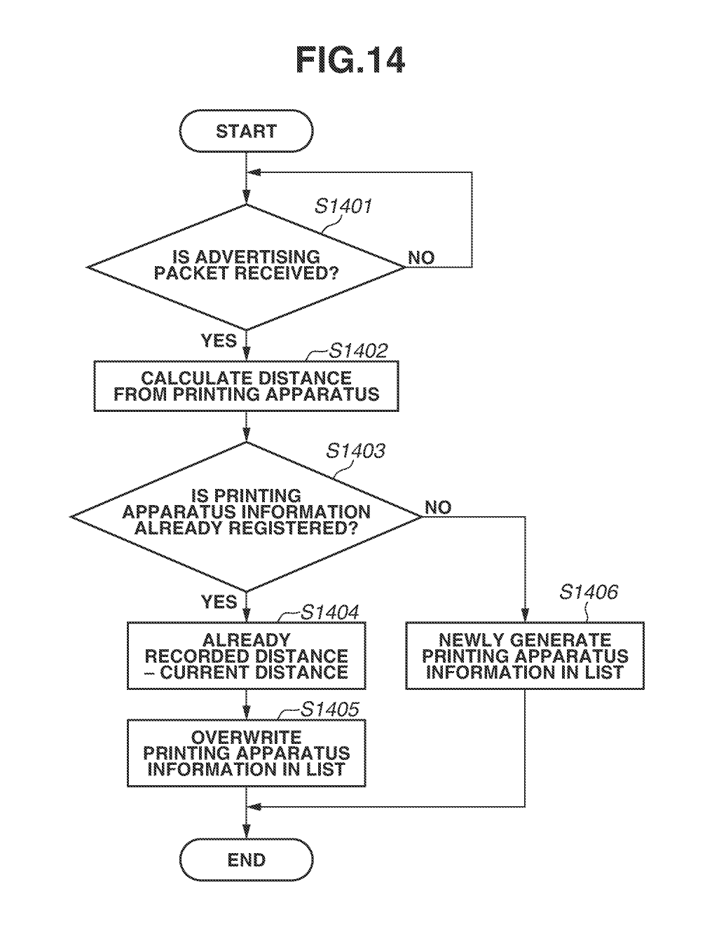

FIG. 14 is a flowchart illustrating processing performed by the mobile terminal apparatus according to the second exemplary embodiment.

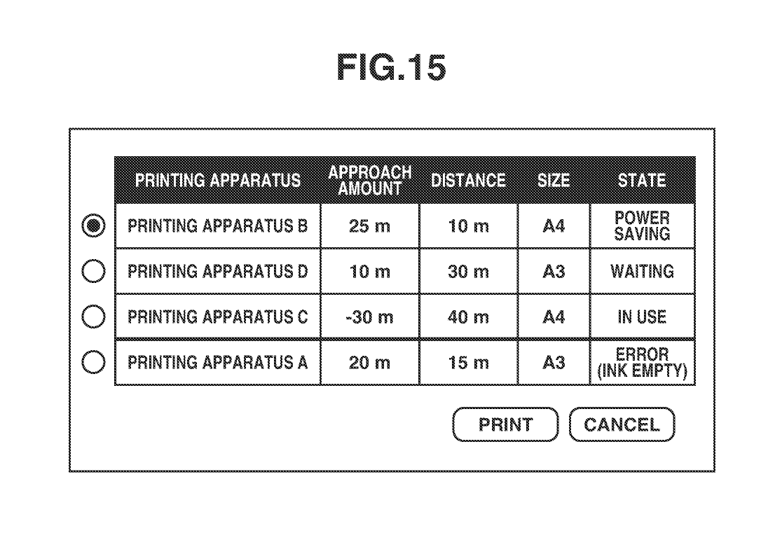

FIG. 15 illustrates one example of the display unit of the mobile terminal apparatus according to the second exemplary embodiment.

### DESCRIPTION OF THE EMBODIMENTS

### Exemplary Embodiments of Present Invention

In the following description, exemplary embodiments of the present invention will be cited as examples and described in detail with reference to the drawings. However, a relative layout among components, display screens, etc., described in these exemplary embodiments is not seen to be limiting.

A first exemplary embodiment will now be described. FIG. 1 illustrates a printing system. The printing system includes a printing apparatus 200 and a mobile terminal apparatus 300. The present exemplary embodiment will be described referring to a method for displaying a printing apparatus list when a user carries out a print job, where the printing apparatus is an example of an image forming apparatus.

The printing apparatus 200 is a multifunctional printer (hereinafter referred to as an MFP), and includes a function of reading an original document placed on a platen glass and a print function using a printing unit, such as an inkjet printer. The MFP can include other functions, such as a facsimile (FAX) function and a telephone function. The printing apparatus 200 is not limited to the above-described example, and can, for example, be a laser beam printer, a copying machine, or a facsimile apparatus. The image processing apparatus is not limited to the printing apparatus and can, for example, be a reading apparatus with a scanner function.

The printing apparatus 200 includes Bluetooth® Low Energy (hereinafter referred to as BLE), which is one of several near field wireless communication standards, and can operate as a peripheral. The printing apparatus 200 can transmit an advertising signal to a surrounding area without being connected to a specific terminal via a network. A signal area 100 refers to an effective communication range of the advertising signal transmitted from the printing apparatus 200.

In the present exemplary embodiment, the mobile terminal apparatus 300 is used as a central, which is a central node of BLE. The mobile terminal apparatus 300 is a portable terminal and can transmit the print job to the printing apparatus 200. The mobile terminal apparatus 300 can be any type of terminal that handles a file to be processed as a print target, such as a file used in a mobile phone, a digital camera, a smartphone, etc. If located within the signal area 100, the mobile terminal apparatus 300 can receive the advertising signal (an advertising packet) transmitted from the printing apparatus 200. Because the mobile terminal apparatus 300 can receive a signal intensity of the advertising signal as a characteristic of BLE, the mobile terminal apparatus 300 can check an approximate distance from the printing apparatus 200.

The signal area 100, which is the effective communication range, is a range where the printing apparatus 200 is communicable, and is a communication range realized by near field wireless communication that covers a shorter communication range than long-range wireless communication, such as a wireless local area network (WLAN) (a shorter communication range than a predetermined distance). Both the printing apparatus 200 and the mobile terminal apparatus 300 can also function as communication apparatuses in a sense that they can communicate with each other.

FIGS. 2A and 2B each illustrate an external view of the printing apparatus 200. A platen glass 211 is a transparent table made of a glass or the like, and an original document is placed on it and read by a scanner. A document cover 212 is a cover for preventing reading light from leaking outwardly when the original document is read by the scanner. A print sheet insertion opening 213 is an insertion opening where sheets of various sizes are set. The sheets set here are conveyed to the printing unit one-by-one, and are discharged from a print sheet discharge opening 214 after being subjected to desired printing. An operation/display unit 215 and a near field communication (NFC) unit 216 are disposed above the document cover 212.

The operation/display unit 215 includes a display screen where an image, an operation menu, e.g., an arrow key, to be used in moving a cursor on the display unit and other keys for carrying out various functions.

The NFC unit 216 is a unit for carrying out the near field communication when a terminal apparatus carrying out the near field communication is brought into close proximity to the NFC unit 216, and the terminal apparatus can communicate therewith by being brought into close proximity to be located within a predetermined distance (approximately 10 cm). When authentication is performed using an integrated circuit (IC) card, the user can transmit and receive authentication information by holding the IC card in close proximity to the NFC unit 216.

A WLAN antenna 217 is an antenna for communicating via the WLAN, and a BLE antenna 218 is an antenna for communicating via BLE. In the present exemplary embodiment, the WLAN antenna 217 and the BLE antenna 218 are embedded inside the printing apparatus 200.

FIG. 3 illustrates an external view of the mobile terminal apparatus 300. In the present exemplary embodiment, a smartphone is used as an example of the mobile terminal apparatus 300. The smartphone refers to a multifunctional mobile phone including a camera, an Internet browser, a mail function, etc. The mobile terminal apparatus 300 includes a BLE unit 301, a WLAN unit 302, a display unit 303, an operation unit 304, and a power source key 305. The BLE unit 301 is a unit for communicating using BLE, and can receive the advertising signal issued from within a range of a predetermined distance (approximately 50 m). The WLAN unit 302 is a unit for communicating via the WLAN. The display unit 303 is a display including a liquid crystal display (LCD)-type display mechanism. The operation unit 304 includes a touch panel-type operation mechanism, and detects information indicating a pressing operation performed by the user. At least a part of the operation unit 304 and the display unit 303 are integrated on the touch panel. On the touch panel, the display unit 303 displays an object, such as a button, and the user presses the operation unit 304, by which the mobile terminal apparatus 300 issues an event corresponding to the pressed button. The power source key 305 is a key enabling the user to power-on and power-off the mobile terminal apparatus 300.

FIG. 4 is a block diagram illustrating an outline of a configuration of the printing apparatus 200. The printing apparatus 200 includes a main board 401 for main control of the apparatus, a WLAN unit 416 for the WLAN communication, an NFC unit 417 for the NFC communication, and a BLE unit 418 for the BLE communication. In the main board 401, a central processing unit (CPU) 402 is a system control unit, and controls the entire printing apparatus 200.

A read only memory (ROM) 403 stores a control program, which is an embedded operating system (OS) program to be executed by the CPU 402. In the present exemplary embodiment, each control program stored in the ROM 403 performs software control, such as scheduling and task switching, under the management of the embedded OS stored in the ROM 403. A random access memory (RAM) 404 is a static RAM (SRAM) or the like, and stores a program control variable and the like. Further, the RAM 404 stores a setting value registered by the user, management data, etc., and includes various types of work buffer areas. A nonvolatile memory 405 is a flash memory or the like, and stores data to be held even when the printing apparatus 200 is powered off. More specifically, the nonvolatile memory 405 stores, for example, user data, such as a telephone number of the facsimile, a communication history, network information, setting information of the printing apparatus 200, such as a list of previously connected apparatus(es), a menu item such as a print mode, information indicating a correction of an inkjet print head, etc. An image memory 406 is a dynamic RAM (DRAM) or the like, and accumulates image data received via each of the communication units, image data processed by a coding/decoding processing unit 412, etc. The memory configuration of the printing apparatus 200 is not limited to the above-described example.

A data conversion unit 407 analyzes, for example, a page description language (PDL), etc., and converts the image data into print data. A reading control unit 408 controls a reading unit 410 to cause the reading unit 410 to read the original document. The reading unit 410 optically reads the original document using a contact image sensor (CIS), and acquires an image signal that is electric image data. Then, the reading unit 410 performs various types of image processing, such as binarization processing or half tone processing, on the image signal via an image processing control unit (not illustrated), and outputs high-resolution image data.

An operation unit 409 and a display unit 411 correspond to the operation/display unit 215 illustrated in FIG. 2B. The coding/decoding processing unit 412 performs coding/decoding processing and enlargement/reduction processing on the image data (Joint Photographic Experts Group (JPEG), Portable Network Graphics (PNG), etc.). A sheet feeding unit 413 holds the sheet to be used in the printing, and the sheet can be fed from the sheet feeding unit 413 under the control of a recording control unit 415. The printing apparatus 200 can include a single sheet feeding unit 413 or can include a plurality of sheet feeding units 413 to hold a plurality of types of sheets in the single apparatus.

The recording control unit 415 can control a sheet feeding unit 413 from which the sheet is fed, in the case where the printing apparatus 200 includes the plurality of sheet feeding units 413. The recording control unit 415 causes a recording unit 414 (also referred to as the printing unit) to print the print data. The image data to be printed is subjected to various types of image processing, such as smoothing processing, processing for correcting a recording density, etc., a color correction, is converted into the print data, and output into the recording unit 414.

The recording control unit 415 is also configured to regularly read out information about the printing unit and update the information in the RAM 404. More specifically, the recording control unit 41 updates a remaining amount in an ink tank, a state of the print head, etc.

The printing apparatus 200 according to the present exemplary embodiment includes the WLAN unit 416, the NFC unit 417, and the BLE unit 418 the three units for realizing the wireless communication. The WLAN unit 416, the NFC unit 417, and the BLE unit 418 carry out data communication with other devices, such as the mobile terminal apparatus 300. The WLAN unit 416, the NFC unit 417, and the BLE unit 418 convert data into a packet and transmit the converted packet to other devices. Conversely, The WLAN unit 416, the NFC unit 417, and the BLE unit 418 convert a packet received from other devices into data, and transmit the converted data to the CPU 402. The WLAN unit 416, the NFC unit 417, and the BLE unit 418 are each connected via a bus cable. The WLAN unit 416, the NFC unit 417, and the BLE unit 418 are units for realizing the communication in compliance with their associated standards. The BLE unit 418 is a unit for use in both Classic Bluetooth® and BLE.

The above-described components 403 to 418 are connected to one another via a system bus 422 managed by the CPU 402.

FIG. 5 is a block diagram illustrating an outline of a configuration of the BLE unit 418. The data to be communicated is transmitted and received between the main board 401 and a microcomputer 503 via a bus cable 421. The BLE unit 418 can handle the data from the bus cable 421 as well as transmit and receive data under different control from the main board 410 with a an internal sensor of the BLE unit 418. A sensor 501 is a device that changes a physical amount generated in a sensing target into an electric signal. Examples of the sensor 501 include a monitoring sensor and a human detection sensor for detecting whether there is a person in front of the printing apparatus 200, a temperature sensor for monitoring a temperature of the printing apparatus 200, etc. An analog-digital converter (ADC) 502 is an analog-digital conversion circuit, and converts an analog signal acquired from the sensor 501 into a digital signal processable by a microprocessor. The microcomputer 503 is a microprocessor that performs processing regarding the wireless communication. A RAM and a flash memory are mounted on this microcomputer 503. A wireless communication circuit 504 includes a wireless communication chip, a crystal oscillator, an inductance, a capacitor, etc., and carries out reception and transmission of the wireless communication. An operation switch 505 is a switch for turning power on and off in a standby state. A battery 506 is a storage battery, such as a button battery. A main body power source 508 is a power source supplied from the main board 401. A power source circuit 507 is a circuit that adjusts a voltage to further efficiently supply power provided from the battery 506. The BLE unit 418 includes two power source systems, the battery 506 and the main body power source 508, which allows the BLE unit 418 to broadcast the advertising signal when the printing apparatus 200 is unable to start up or when the main board 401 is powered off to save power of the main body. Further, the BLE unit 418 includes a nonvolatile memory 509, and can communicate by itself by transferring information from the main board 401 into the nonvolatile memory 509 in advance.

FIG. 6 illustrates a block diagram of the mobile terminal apparatus 300. The mobile terminal apparatus 300 includes a main board 601, which is configured to perform main control of the apparatus, a WLAN unit 616, which is configured to perform the WLAN communication, an NFC unit 617, which is configured to perform the NFC communication, and a BLE unit 618, which is configured to perform the BLE communication. In the main board 601, a CPU 602 is a system control unit, and controls the entire mobile terminal apparatus 300. A ROM 603 stores a control program to be executed by the CPU 602, which is an embedded OS program. In the present exemplary embodiment, each control program stored in the ROM 603 performs software control, such as scheduling and task switching, under the management of the embedded OS stored in the ROM 603. A RAM 604 includes an SRAM (static RAM) or the like, and stores a program control variable and the like. Further, the RAM 604 stores a setting value registered by the user, management data of the mobile terminal apparatus 300, and includes buffer areas for various types of work. In the present exemplary embodiment, the RAM 604 stores a list of printing apparatus(es) as the management target data of the mobile terminal apparatus 30. An image memory 605 includes a DRAM or the like, and temporarily stores image data received via the communication unit or image data read out from a data accumulation unit 612 so that the CPU 602 processes them. A nonvolatile memory 613 includes a flash memory or the like, and stores data to be stored even after the mobile terminal apparatus 300 is powered off. Examples of the data stored in the nonvolatile memory 613 include, but are not limited to, telephone directory information, information indicating a previously connected device, etc. The memory configuration of the mobile terminal apparatus 300 is not limited to the above-described example. For example, the image memory 605 and the RAM 604 can share a common memory, and the data accumulation unit 612 can be used for a data backup. Further, in the present exemplary embodiment, the mobile terminal apparatus 300 employs the DRAM, but can employ a hard disk, a nonvolatile memory, etc., so that the type of the employed memory is not limited thereto.

A data conversion unit 606 carries out an analysis of the PDL and data conversion, such as color conversion and image conversion. A telephone unit 607 controls a telephone line and realizes communication via a telephone by processing audio data input and output via a speaker unit 614. An operation unit 608 controls a signal of the operation unit 304 illustrated in FIG. 3. A global positioning system (GPS) 609 acquires current latitude and longitude associated with the mobile terminal apparatus 300. A display unit 610 electronically controls display content on the display unit 303, and can display various types of input operations, an operation state of the printing apparatus 200, which is an external apparatus, and a status of the apparatus.

A camera unit 611 includes a function of electronically recording an image input via a lens by coding the image. The image captured by the camera unit 611 is stored in the data accumulation unit 612. The speaker unit 614 realizes a function of inputting or outputting a sound and a voice for the telephone function, as well as other functions, such as an alarm notification. A power source unit 615 controls a portable battery. Power states include a battery-empty state, in which no remaining power is left in the battery, a powered-off state, in which the power source key 305 is not pressed, a started-up state, in which the mobile terminal apparatus 300 is normally started up, and a power-saving state, in which the mobile terminal apparatus 300 is already started up but is in operation in a power saving mode.

The mobile terminal apparatus 300 according to the present exemplary embodiment includes the WLAN unit 616, the NFC unit 617, and the BLE unit 618 for realizing the wireless communication. The WLAN unit 616, the NFC unit 617, and the BLE unit 618 are each connected via a bus cable or the like. The WLAN unit 616, the NFC unit 617, and the BLE unit 618 are units for realizing the communication in compliance with their associated standards. The BLE unit 618 is a unit for use in both Classic Bluetooth® and BLE. The mobile terminal apparatus 300 causes the printing apparatus 200, which is the external apparatus, to perform the print processing by transmitting the print data to the printing apparatus 200 via the WLAN unit 616, the NFC unit 617, or the BLE unit 618.

The above-described components 603 to 618 are connected to one another via a system bus 622 managed by the CPU 602.

FIGS. 7A to 7D illustrate a detailed configuration of the advertising packet issued by the printing apparatus 200. Upon a transition to a powered-on state, the BLE unit 418 performs initializing processing, and transitions to an advertising state of transmitting and receiving the advertising packet. When transitioning to the advertising state, the BLE unit 418 issues the advertising packet illustrated in FIG. 7A to the surrounding area at a settable interval. The advertising packet includes a header 701 of two bytes, and a payload 702. The header 701 is an area storing a type of the packet, information indicating a size of the payload 702, etc. The payload 702 is an area storing information about the apparatus that transmits the advertising signal and is allocated a predetermined size.

In addition to storing a device name and information indicating a mounted profile, the payload 702 can store information regarding the printing apparatus 200, such as transmission power (Tx Power 708). The mobile terminal apparatus 300 can calculate a propagation loss from a value of the Tx Power 708 and the signal intensity of the received packet, and can estimate the distance from the BLE wireless device. Next, details of the payload 702 will be described. A printing apparatus name 703 stores a name for identifying the printing apparatus 200. For example, to uniquely identify the printing apparatus 200 in an office environment, a character string can be set. Information 704 connecting to the printing apparatus 200 stores information enabling the mobile terminal apparatus 300 receiving the advertising packet to connect to the printing apparatus 200. If the BLE standard is supported, the mobile terminal apparatus 300 can establish a connection to the printing apparatus 200 and, after establishment of the connection, carry out the data communication by transmitting and receiving a protocol data unit (PDU), which is data of the protocol defined in the BLE 4.0 standard. Further, the connection can also be established by a method other than BLE. For example, the mobile terminal apparatus 300 can also connect to the printing apparatus 200 via the WLAN by setting information for a connection to the WLAN unit 416 in advance.

Capability information 705 will be described with reference to FIG. 7B. This information is information indicating a capability about a job that the printing apparatus 200 can carry out, and is configured for a purpose of broadcasting this information to an apparatus located in the vicinity of the printing apparatus 200 (the mobile terminal apparatus 300 in the present exemplary embodiment). A user of the mobile terminal apparatus 300 can check what types of functions the printing apparatus 200 can perform, without establishing the connection to the printing apparatus 200, by just receiving the capability information 705. In the present exemplary embodiment, the payload 702 includes manufacturer information (hereinafter referred to a manufacturer 709), model number information (hereinafter referred to as a model number 710), color information (hereinafter referred to as a color 711), and ink number information (hereinafter referred to as an ink number 712) as the capability information 705. Further, the payload 702 includes information indicating a size of a supported sheet (hereinafter referred to as a supported sheet size 713), information indicating a type of the supported sheet (hereinafter referred to as a supported sheet type 714), and information indicating whether the printing apparatus 200 is capable of two-sided printing (hereinafter referred to as two-sided support 715) as the capability information 705. The manufacturer 709 stores a manufacturer identification (ID) assigned for each manufacturer. The model number 710 stores an ID for uniquely identifying a product model of the printing apparatus 200. The color 711 stores a flag indicating whether the printing apparatus 200 is a color printer or a monochrome printer. A bit is allocated for each ink color in the ink number 712, and the ink number 712 can indicate a mountable ink. A bit is allocated for each sheet size in the supported sheet size 713, and the supported sheet size 713 can indicate a settable sheet size. A bit is allocated for each sheet type in the supported sheet type 714, and the supported sheet type 714 can indicate a settable sheet type. The two-sided support 715 stores a flag indicating whether the printing apparatus 200 is capable of the two-sided printing. The capability information 705 identifies the functions of the printing apparatus 200 such that the mobile terminal apparatus 300 can determine whether the printing apparatus 200 can carry out the job that the user is attempting to perform.

Next, setting information 706 will be described with reference to FIG. 7C. This setting information 706 is information currently set in the printing apparatus 200. The user of the mobile terminal apparatus 300 can check a state of the current settings of the printing apparatus 200 without establishing the connection to the printing apparatus 200, by receiving the setting information 706. The setting information 706 includes a sheet size 716 of a cassette 1 and a sheet size 717 of a cassette 2, and respectively store sizes of sheets set in the cassettes 1 and 2. Setting values thereof are defined in a similar manner to the bit defined in the supported sheet size 713, but are not limited thereto. The setting information 706 includes a sheet type 718 of the cassette 1 and a sheet type 719 of the cassette 2, and respectively store types of sheets set in the cassettes 1 and 2. Setting values thereof are assumed to be defined in a similar manner to the bit defined in the supported sheet type 714, but are not limited thereto. A prioritized cassette 720 indicates which cassette is preferentially used between the cassettes (the cassettes 1 and 2) included in the printing apparatus 200. A print mode 721 stores a value indicating a default print mode. A value indicating various types of print modes, such as “fine”, “standard”, and “fast”, can be set as the value thereof. A print speed 722 stores a print speed currently set in the printing apparatus 200. For example, the print speed 722 stores, as a guide, the estimated number of sheets printable per minute at the time of printing on plain paper of an A4 sheet size in the fine mode. The user can check the current setting information of the printing apparatus 200 in this manner, and can use this information as a clue to discover a desired printing apparatus 200. Further, the user can check the functions executable by the printing apparatus 200 and the current settings of the printing apparatus 200 in advance, and can recognize that the user should go to the printing apparatus 200 and change the settings in advance. Therefore, the user can prevent execution of the printing with unintended settings.

Next, error information 707 will be described with reference to FIG. 7D. This error information 707 is error information 707 indicating an error occurring in the printing apparatus 200. The user of the mobile terminal apparatus 300 can detect that occurrence of an error in the printing apparatus 200 without establishing the connection to the printing apparatus 200, by just receiving the error information 707. The payload 702 includes information indicating a status of the job (hereinafter referred to as a job status 723), information indicating a job error (hereinafter referred to as a job error 724), information indicating a recoverable error (hereinafter referred to as a recoverable error 725), and information indicating a fatal error (hereinafter referred to as a fatal error 726) as the error information 707. The job status 723 stores the number of received job(s), the number of received page(s), and the number of user(s) in the vicinity. The mobile terminal apparatus 300 can estimate (check) approximately how long the mobile terminal apparatus 300 should wait when the job is transmitted by checking the number of received job(s) and the number of received page(s). Further, regarding the number of user(s) in the vicinity, the printing apparatus 200 can estimate (check) the number of mobile terminal apparatus(es) 300 located in the vicinity of the printing apparatus 200 by broadcasting the advertising packet and counting the number of response(s) returned thereto in advance. The printing apparatus 200 can simply use the number of mobile terminal apparatus(es) 300 that have provided response(s) or can use the number of mobile terminal apparatus(es) 300 located within a predetermined distance. The job error 724 stores a value indicating a content of the error that occurred when the printing apparatus 200 received and carried out the job. In the present exemplary embodiment, errors detectable as the job error include, but are not limited to, a mismatch of sheet size, a mismatch of sheet type, an image decoding error, a packet error, a color mismatch, an imposition error, unsupported processing, etc. Errors occur, for example, when job data is incorrect or when settings of the transmitted job and the setting information of the printing apparatus 200 do not match each other. In such cases, most of the errors can be resolved by re-transmitting an appropriate job from the mobile terminal apparatus 300 or changing the settings of the printing apparatus 200. In the present exemplary embodiment, a bit is allocated for each job error, and the mobile terminal apparatus 300 can be notified even when a plurality of errors has occurred. The mobile terminal apparatus 300 can check the job error in the printing apparatus 200, thus enabling the user to determine whether to use the printing apparatus 200 after resolving the error in the printing apparatus 200 or to use another printing apparatus 200. The recoverable error 725 stores a value indicating an error that occurred in the printing apparatus 200 and requires the user to go to the printing apparatus 200 to attend to maintenance. The value indicating the error is assigned for each bit, similar to the job error 724. In the present exemplary embodiment, errors detectable as the recoverable error include, but are not limited to, a paper jam at a conveyance unit, a paper jam at the sheet feeding unit, a sheet tray full, the discharge opening closed, the cover opened, out of ink, remaining ink low, etc. The recoverable error 725 enables the user who has transmitted the job as well as a user located in the vicinity of the printing apparatus 200 to check the error, thus improving maintainability of the printing apparatus 200. The fatal error 726 stores a value indicating an error difficult for the user to provide the maintenance for from among errors that occur in the printing apparatus 200. The occurrence of this error raises the necessity of contacting a service center, and it is typically not feasible for the user to recover the printing apparatus 200. In the present exemplary embodiment, errors detectable as the fatal error include, but are not limited to, a waste ink tank full, a high temperature of the printing unit, a power source error, etc. The mobile terminal apparatus 300 can detect that the fatal error has occurred in the printing apparatus 200 based on the fatal error 726. Therefore, the mobile terminal apparatus 300, which is attempting to carry out the job, can exclude the printing apparatus 200 from available printing apparatuses.

As described with reference to FIGS. 7A to 7D, the mobile terminal apparatus 300 can check the information about the printing apparatus 200 by receiving the predetermined packet of the printing apparatus 200. In addition to the above-described information, arbitrary data can also be stored in the advertising packet and broadcasted. For example, in the present exemplary embodiment, NEXT Flag 727 can also be added as illustrated in FIG. 7A. This addition enables the advertising packet to indicate that the information could not be stored in the present advertising packet, but will be broadcast by a next advertising packet. In addition to the payload 702 being structured according to the determined format, a bit indicating a mode of transmitting an arbitrary character string can also be defined in the payload 702.

FIG. 8 is a schematic view illustrating a relationship between each of a plurality of printing apparatus and the mobile terminal apparatus 300. The present exemplary embodiment will be described with respect to a case where there is a plurality of printing apparatuses in the vicinity of the mobile terminal apparatus 300 as illustrated in FIG. 8. When a printing apparatus A 201 issues the advertising packet, a signal area A 101 is established as the effective communication range. When a printing apparatus B 202 issues the advertising packet, a signal area B 102 is established as the effective communication range. When a printing apparatus C 203 issues the advertising packet, a signal area C 103 is established as the effective communication range. When a printing apparatus D 204 issues the advertising packet, a signal area D 104 is established as the effective communication range. When located within the signal area A 101, the mobile terminal apparatus 300 can receive the advertising packet issued from the printing apparatus A 201. When located within the signal area B 102, the signal area C 103, and the signal area D 104, the mobile terminal apparatus 300 can receive the advertising packets issued from the printing apparatus B 202, the printing apparatus C 203, and the printing apparatus D 204, respectively.

FIG. 9 illustrates a sequence until the mobile terminal apparatus 300 illustrated in FIG. 8 selects one printing apparatus from the plurality of printing apparatuses A 201, B 202, C 203, and D 204 when carrying out the print job. Each of the printing apparatus A 201, the printing apparatus B 202, the printing apparatus C 203, and the printing apparatus D 204 is an advertiser, and issues the advertising packet to the surrounding area at an arbitrary advertising interval. The advertising interval can be set within a range from 20 milliseconds to 10.24 seconds. After start up, the mobile terminal apparatus 300 transitions to a scanning state and waits for the advertising packet in a reception state. In each of steps S901, S904, and S908, the printing apparatus A 201 issues the advertising packet at an advertising interval Ta 950. If located within the signal area A 101, the mobile terminal apparatus 300 receives this advertising packet. Then, in each of steps S921, S924, and S928, the mobile terminal apparatus 300 records the information into the RAM 604. Similarly, in each of steps S902 and S905, the printing apparatus B 202 issues the advertising packet at the arbitrary advertising interval. In each of steps S903 and S907, the printing apparatus C 203 issues the advertising packet at the arbitrary advertising interval. In each of steps S906 and S909, the printing apparatus D 204 issues the advertising packet at the arbitrary advertising interval. In each of steps S922 and S925, the mobile terminal apparatus 300 receives the advertising packet issued from the printing apparatus B 202 and records the information into the RAM 604 if being located within the signal area B 102. In each of steps S923 and S927, the mobile terminal apparatus 300 receives the advertising packet issued from the printing apparatus C 203 and records the information into the RAM 604 if being located within the signal area C 103. In each of steps S926 and S929, the mobile terminal apparatus 300 receives the advertising packet issued from the printing apparatus D 204 and records the information into the RAM 604 if located within the signal area D 104. In step S990, the mobile terminal apparatus 300 displays a list of printing apparatus(es) located in the vicinity of the mobile terminal apparatus 300 based on the printing apparatus information recorded in the RAM 604 when the user carries out the print job, i.e., when the mobile terminal apparatus 300 is instructed to carry out the print job on the operation unit 304 illustrated in FIG. 3.

FIG. 10 illustrates a flow of processing performed by the mobile terminal apparatus 300 according to the present exemplary embodiment in each of steps S921 to S929. The CPU 602 of the mobile terminal apparatus 300 reads out and executes the program stored in the ROM 603, by which the processing illustrated in this flowchart is realized.

In step S1001, the mobile terminal apparatus 300 transitions to the scanning state and waits for the advertising packet in the reception state after activating the BLE communication. If the mobile terminal apparatus 300 receives the advertising packet in step S1001 (YES in step S1001), in step S1002, the mobile terminal apparatus 300 calculates the distance between the mobile terminal apparatus 300 and the printing apparatus from Tx Power 708 in the advertising packet and the signal intensity when the advertising packet has been received. In other words, the mobile terminal apparatus 300 checks the distance from the printing apparatus based on Tx Power 708 in the advertising packet and the signal intensity when the advertising packet has been received. In step S1003, the mobile terminal apparatus 300 determines whether the received information about the printing apparatus is the information of the printing apparatus already registered with the printing apparatus list in the ROM 604. The mobile terminal apparatus 300 uses the printing apparatus name 703 in the advertising packet to check the printing apparatus. If the printing apparatus is already registered in the printing apparatus list (YES in step S1003), in step S1004, the mobile terminal apparatus 300 overwrites the printing apparatus information in the printing apparatus list in the ROM 604 with the received printing apparatus information. In step S1004, the mobile terminal apparatus 300 updates (overwrites), based on the advertising packet, at least a part (for example, the error information and information regarding the distance (hereinafter referred to as distance information)) of the printing apparatus information. If no corresponding printing apparatus is registered with the printing apparatus list (NO in step S1003), in step S1005, the mobile terminal apparatus 300 newly adds the printing apparatus information in the printing apparatus list in the RAM 604. The above-described processing flow is performed based on the advertising packet transmitted from each of the printing apparatuses A 201, B 202, C 203, and D 204. FIG. 11 illustrates a flow of processing for deleting at least a part (for example, the error information and the distance information) of the printing apparatus information from the printing apparatus list of the mobile terminal apparatus 300 according to the present exemplary embodiment. The CPU 602 of the mobile terminal apparatus 300 reads out and executes the program stored in the ROM 603 to realize the processing illustrated in this flowchart.

The advertising interval is determined to be 20 milliseconds to 10.24 seconds by the BLE specification. Therefore, if the printing apparatus is not updated in the printing apparatus list for 10.24 seconds or longer, the mobile terminal apparatus 300 is considered to have moved out from its own signal area or powered off. In these cases, the mobile terminal apparatus 300 cannot use this printing apparatus.

In the present exemplary embodiment, the mobile terminal apparatus 300 regularly monitors the printing apparatus list. In step S1101, the mobile terminal apparatus 300 monitors whether any printing apparatus information that has not been updated for 10.24 seconds or longer in the printing apparatus list. If the printing apparatus information of some printing apparatuses has not been updated for 10.24 seconds or longer (YES in step S1101), in step S1102, the mobile terminal apparatus 300 deletes the printing apparatus information of the printing apparatuses in question from the printing apparatus list. In the present exemplary embodiment, the display on the display unit 303 of the mobile terminal apparatus 300 is controlled based on the information acquired from the above-described advertising packet. The display on the display unit 303 is controlled by the CPU 602. In other words, the mobile terminal apparatus 300 displays a predetermined display screen on the display unit 303 based on the control of the CPU 602.

FIGS. 12A and 12B each illustrate one example of the display screen on the display unit 303 of the mobile terminal apparatus 300 when the user carries out the print job. As described above, in response to the instruction to carry out the print job on the operation unit 304 illustrated in FIG. 3, the mobile terminal apparatus 300 displays the list of printing apparatus(es) located in the vicinity of the mobile terminal apparatus 300 from the printing apparatus information recorded in the RAM 604. More specifically, first, a screen for setting the print job is displayed on the display unit 303 as illustrated in FIG. 12A. The print settings of the print job can be made on the setting screen. More specifically, for example, a size of the original document, a setting specifying whether the printing is color printing or monochrome printing, a setting specifying whether the printing is two-sided printing or one-sided printing, can be set from pull-down menus. In the present example, the print settings of the print job are selectable from the pull-down menus, but the setting screen can be configured to enable the user to directly input them. When an OK button is pressed on the setting screen, the print settings of the print job set by the user are entered.

After the print settings of the print job are entered via the setting screen, the mobile terminal apparatus 300 displays a screen for selecting the printing apparatus as illustrated in FIG. 12B. As illustrated in FIG. 12B, the mobile terminal apparatus 300 displays the list of printing apparatus(es) located in the vicinity of the mobile terminal apparatus 300 on the selection screen. The printing apparatus list is displayed based on the advertising packet(s) received by the mobile terminal apparatus 300. More specifically, when displaying the selection screen, the mobile terminal apparatus 300 acquires the printing apparatus list in the RAM 604 that is updated based on the processing flow illustrated in FIG. 10, and presents the display based on the acquired printing apparatus list. At this time, the mobile terminal apparatus 300 displays the list of printing apparatus(es) registered in the printing apparatus list in the RAM 604, i.e., the list of printing apparatus(es), each of which is a transmission source of the received advertising packet. Further, in the present exemplary embodiment, the mobile terminal apparatus 300 displays only the printing apparatus(es) supporting the print settings set by the user in FIG. 12A. In other words, the mobile terminal apparatus 300 displays, on the selection screen, the printing apparatus(es) equipped with a capability supporting the print settings made by the user on the setting screen.

The mobile terminal apparatus 300 displays the printing apparatus(es) in a manner arranged in order of the distance from the mobile terminal apparatus 300 on this selection screen. In the present exemplary embodiment, the mobile terminal apparatus 300 displays the printing apparatus(es) in a manner arranged in ascending order of the distance.

In the present exemplary embodiment, the mobile terminal apparatus 300 lowers display priority assigned to the printing apparatus in the list that is in an error state regardless of the distance from the mobile terminal apparatus 300. In FIG. 12B, the mobile terminal apparatus 300 displays the printing apparatus in the error state at a lowermost position.

The mobile terminal apparatus 300 displays the name of the printing apparatus, the distance from the printing apparatus, the supported size, and the state of the printing apparatus for each printing apparatus. The user can select the printing apparatus to be used in the printing by selecting a button configured beside the display of the name of the printing apparatus. If a print button on the selection screen is pressed, the print data is transmitted to the selected printing apparatus, and the printing is carried out. If a cancel button on the selection screen is pressed, the selection screen is closed. At this time, the print data can be transmitted using the BLE communication or using other communication methods.

Although not illustrated, the mobile terminal apparatus 300 can be configured in such a manner that the selection of the printing apparatus in FIG. 12B triggers a display of detailed information about the printing apparatus. Examples of the detailed information include, but are not limited to, supported sheet type, print speed, print cost, model number of the printing apparatus, etc. The detailed display information is based on, for example, the capability information 705, the setting information 706, and the error information 707 contained in the advertising packet.

The mobile terminal apparatus 300 is configured in the above-described manner, which enables the user to select the printing apparatus after configuring the print settings of the print job in the present exemplary embodiment. This enables the user to easily select the printing apparatus suited to the print job. Further, the mobile terminal apparatus 300 displays the printing apparatus(es) in the manner arranged in ascending order of the distance from the mobile terminal apparatus 300, which enables the user to easily select the printing apparatus located a short distance away therefrom.

The mobile terminal apparatus 300 displays the supported size and the state of the printing apparatus on the selection screen, which enables the user to determine and select which printing apparatus is suited to carry out the printing.

In the present exemplary embodiment, the mobile terminal apparatus 300 displays the printing apparatus in the error state at the undermost position, which enables the user to easily select the printing apparatus suited to the printing.

The mobile terminal apparatus 300 can be configured to update the display on the selection screen illustrated in FIG. 12B in a predetermined cycle. This is because the printing apparatus list is updated by the processing flows illustrated in FIGS. 10 and 11. The mobile terminal apparatus 300 can present the display that reflects the positional relationship with the printing apparatus by updating the display on the selection screen in the predetermined cycle. For example, a movement of the mobile terminal apparatus 300 causes a change in the distance from the printing apparatus, thereby resulting in a change in the order of displaying the printing apparatus(es) on the selection screen. A movement of the mobile terminal apparatus 300 out of the signal area of some printing apparatuses causes the display of these printing apparatuses to be deleted from the selection screen.

In a second exemplary embodiment of the present invention, the display screen displayed on the display unit 303 is controlled according to the movement of the mobile terminal apparatus 300. The second exemplary embodiment will be described omitting descriptions overlapping with the first exemplary embodiment. Further, similar features to the first exemplary embodiment will be indicated by the same reference numerals as the first exemplary embodiment.

FIG. 13 is a schematic view illustrating a relationship between each of the plurality of printing apparatuses A 201, B 202, C 203, and D 204 and the mobile terminal apparatus 300 according to the second exemplary embodiment. The descriptions of the printing apparatus A 201, the printing apparatus B 202, the printing apparatus C 203, the printing apparatus D 204, and the mobile terminal apparatus 300 are similar to FIG. 8, and therefore will be omitted. The mobile terminal apparatus 300 is assumed to be held by a person. When the person moves, the mobile terminal apparatus 300 also moves accordingly. If the mobile terminal apparatus 300 is located at a position P, the distance from the printing apparatus A 201 is R1. After some arbitrary time period has elapsed, the distance from the printing apparatus A 201 is R2 if the mobile terminal apparatus 300 has moved and is located at a position Q. In this manner, the mobile terminal apparatus 300 approaches the printing apparatus A 201 by an arbitrary distance R1-R2. The same applies to the relationship between each of the other printing apparatuses, the printing apparatus B 202, the printing apparatus C 203, and the printing apparatus D 204, and the mobile terminal apparatus 300, and the distances therefrom also change according to the movement of the mobile terminal apparatus 300.

FIG. 14 illustrates a flow of processing for generating the printing apparatus list by the mobile terminal apparatus 300 according to the second exemplary embodiment. Steps S1401 to S1403 are similar to steps S1001 to S1003, and therefore descriptions thereof will be omitted. In step S1403, the mobile terminal apparatus 300 determines whether the received information about the printing apparatus is already registered in the printing apparatus list in the RAM 604.

If this printing apparatus is the apparatus already registered in the printing apparatus list (YES in step S1403), in step S1404, the mobile terminal apparatus 300 calculates an amount of the approach to the printing apparatus. More specifically, the mobile terminal apparatus 300 calculates the amount of the approach to the printing apparatus by subtracting the current distance of the printing apparatus acquired in step S1402 from the distance of the printing apparatus registered in the printing apparatus list (i.e., the distance from the printing apparatus acquired and registered in step S1402 in previous execution of the processing). If the calculation yields a negative result, this means that the mobile terminal apparatus 300 is moving away from the printing apparatus. If the calculation yields a positive result, this means that the mobile terminal apparatus 300 is approaching the printing apparatus. In this manner, in the present exemplary embodiment, the mobile terminal apparatus 300 calculates the amount of the movement of the mobile terminal apparatus 300 toward the printing apparatus based on a difference between the currently acquired value and the previously acquired value. Then, in step S1405, the mobile terminal apparatus 300 overwrites the printing apparatus information into the RAM 604 and registers the approach amount acquired in step S1404 along with it.

If the received information about the printing apparatus is the printing apparatus not registered in the printing apparatus list in the RAM 604 in step S1403 (NO in step S1403), in step S1406, the mobile terminal apparatus 300 newly adds the printing apparatus information to the printing apparatus list. In this case, the mobile terminal apparatus 300 cannot obtain the difference from the previous distance, and therefore sets the approach amount to zero.

FIG. 15 illustrates one example of a selection screen on the display unit 303 of the mobile terminal apparatus 300 according to the second exemplary embodiment. The selection screen illustrated in FIG. 15 is displayed after the setting screen illustrated in FIG. 12A is displayed and the print settings of the print job are determined. As illustrated in FIG. 15, the mobile terminal apparatus 300 displays the list of printing apparatus(es) located in the vicinity of the mobile terminal apparatus 300 on the selection screen. At this time, the mobile terminal apparatus 300 displays the printing apparatus(es) in descending order of the approach amount. Although not illustrated in FIG. 15, the mobile terminal apparatus 300 can be configured to, if there is a printing apparatus with respect to which the approach amount cannot be acquired, display this printing apparatus at the lowermost position among the printing apparatus(es), except for the printing apparatus in the error state. Alternatively, the mobile terminal apparatus 300 can be configured to sort the printing apparatus(es) assuming that the approach amount is zero for the printing apparatus with respect to which the approach amount cannot be acquired. In other words, in the case of FIG. 15, the mobile terminal apparatus 300 displays the printing apparatus with respect to which the approach amount cannot be acquired between the printing apparatus D and the printing apparatus C.

In the present exemplary embodiment, the mobile terminal apparatus 300 reduces the priority assigned to the display in the list regardless of the distance from the mobile terminal apparatus 300. In FIG. 15, the mobile terminal apparatus 300 displays the printing apparatus in the error state at the lowermost position.

The mobile terminal apparatus 300 displays the name of the printing apparatus, the approach amount, the distance from the printing apparatus, the supported size, and the state of the printing apparatus, for each printing apparatus. The user can select the printing apparatus to be used in the printing by selecting a button set beside the display of the name of the printing apparatus. Then, if a print button on the selection screen is pressed, the print data is transmitted to the selected printing apparatus, and the printing is carried out. If a cancel button on the selection screen is pressed, the selection screen is closed. At this time, the print data can be transmitted with use of the BLE communication or with use of any other type of communication.

The printing apparatus list is displayed based on the advertising packet(s) received by the mobile terminal apparatus 300. More specifically, the mobile terminal apparatus 300 presents the display based on the printing apparatus list in the RAM 604 that is updated based on the processing flow illustrated in FIG. 14. At this time, the mobile terminal apparatus 300 displays the list of printing apparatus(es) registered in the printing apparatus list in the RAM 604, i.e., the list of printing apparatus(es), each of which is the transmission source of the received advertising packet. In the present exemplary embodiment, the mobile terminal apparatus 300 displays just the printing apparatus(es) compatible with the print settings set by the user in FIG. 12A.

Thus, the mobile terminal apparatus 300 enables the user to select the printing apparatus after configuring the print settings of the print job in the present exemplary embodiment. This enables the user to easily select the printing apparatus suited to the print job. Further, the mobile terminal apparatus 300 displays the printing apparatus(es) in the manner arranged in descending order of the approach amount as viewed from the mobile terminal apparatus 300, which enables the user to easily select the printing apparatus that the user approaching.

The mobile terminal apparatus 300 displays the supported size and the state of the printing apparatus on the selection screen, which enables the user to determine and select which printing apparatus is best suited to carry out the printing.

Further, in the present exemplary embodiment, the mobile terminal apparatus 300 displays the printing apparatus in the error state at the undermost position, which enables the user to easily select the printing apparatus suited to the printing.

According to the present exemplary embodiment, the user can easily select a desired printing apparatus. The present exemplary embodiment also facilitates the user's selection according to the distance from the image processing apparatus.

### Other Exemplary Embodiments

The present invention is not limited to the above-described exemplary embodiments. For example, in the above-described exemplary embodiments, the mobile terminal apparatus 300 is configured to display the printing apparatus in the error state at the lowermost position on the selection screen, but the present invention is not limited thereto. For example, the mobile terminal apparatus 300 can be configured to gray out the printing apparatus in the error state to prohibit the user from selecting it on the selection screen. Alternatively, for example, the mobile terminal apparatus 300 can be configured to display the printing apparatus in the error state to make the printing apparatus distinguishable by, for example, displaying the printing apparatus in a different color from the printing apparatus where no error has occurred.

In FIG. 12B, the mobile terminal apparatus 300 is configured to display the printing apparatus(es) in ascending order of the distance from the mobile terminal apparatus 300, but the mobile terminal apparatus 300 can be configured to display a sort button on the screen illustrated in FIG. 12B, thereby enabling the user to sort the printing apparatus(es) by the supported size, the state of the printing apparatus, etc. In other words, the mobile terminal apparatus 300 can be configured to enable the user to sort the printing apparatus(es) by an item specified by the user. This sortability enables the user to easily select the desired printing apparatus. Similarly, in FIG. 15, the mobile terminal apparatus 300 is configured to display the printing apparatus(es) in descending order of the approach amount as viewed from the mobile terminal apparatus 300, but the mobile terminal apparatus 300 can be configured to display the sort button on the screen illustrated in FIG. 15, thereby enabling the user to sort the printing apparatus(es) by the supported size, the state of the printing apparatus, etc.

In the above-described exemplary embodiments, the mobile terminal apparatus 300 is configured to display the printing apparatus in the error state at the lowermost position in the list on the selection screen, but the present invention is not limited thereto. The mobile terminal apparatus 300 can be configured to display the printing apparatus unsupported by the mobile terminal apparatus 300 at a lower position in the list on the selection screen. This display can prevent or discourage the user from selecting the printing apparatus unsupported by the mobile terminal apparatus 300.

The above-described exemplary embodiments have been described referring to the processing performed by the printer notifying the mobile terminal of the advertising signal of BLE, but a different signal from the advertising signal of BLE can be used to notify the mobile terminal of the presence of the printer. For example, the printer can notify the mobile terminal of the presence of the printer using notification of a signal based on the Wireless Fidelity (WiFi®) function.

Then, information similar to the exemplary embodiments of the present invention can be contained in the signal based on the WiFi® function issued from the printer.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While aspects of the present invention have been described with reference to exemplary embodiments, it is to be understood that the aspects of the invention are not limited to the disclosed exemplary embodiments. The scope of the following claims is to be accorded the broadest interpretation so as to encompass all such modifications and equivalent structures and functions.

This application claims the benefit of Japanese Patent Application No. 2015-157608, filed Aug. 7, 2015, which is hereby incorporated by reference herein in its entirety.

What is claimed is:

1. An information processing apparatus comprising:
a reception unit configured to receive a signal transmitted from an external apparatus;
a specifying unit configured to specify a distance from the external apparatus based on the received signal;
a display control unit configured to cause a display unit to display a selection screen for selecting the external apparatus based on the received signal; and
a transmission unit configured to transmit data to the selected external apparatus,
wherein, if the reception unit receives signals from a plurality of external apparatuses, the display control unit causes the display unit to display the plurality of external apparatuses on the selection screen in order of distance based on the specified distance, and
wherein, if the reception unit receives a signal of a first external apparatus having an error occurring therein and a signal of a second external apparatus located farther away from the information processing apparatus than the first external apparatus and having no error occurring therein, the display control unit causes the display unit to display the second external apparatus in priority to the first external apparatus.

2. The information processing apparatus according to claim 1, wherein the display control unit causes the display unit to display the second external apparatus higher than the first external apparatus in a list of the plurality of external apparatuses on the selection screen.

3. The information processing apparatus according to claim 1, wherein the display control unit assigns a lower priority to a display of the external apparatus having the error occurring therein than a priority assigned to a display of the external apparatus having no error occurring therein on the selection screen.

4. The information processing apparatus according to claim 1, wherein the occurrence of the error in the external apparatus is detected based on the received signal.

5. The information processing apparatus according to claim 1, further comprising a storage control unit configured to store information regarding the external apparatus based on the received signal,
wherein the storage control unit updates the stored information regarding the external apparatus when the reception unit receives the signal, and
wherein the selection screen is configured to prohibit a selection of the external apparatus corresponding to the information regarding the external apparatus that has not been updated for a predetermined time period or longer, from among pieces of stored information regarding the external apparatuses.

6. The information processing apparatus according to claim 5, wherein the external apparatus, which corresponds to the information regarding the external apparatus that has not been updated for the predetermined time period or longer from among the pieces of stored information regarding the external apparatuses, is not displayed on the selection screen.

7. The information processing apparatus according to claim 5, wherein the storage control unit deletes the information regarding the external apparatus that has not been updated for the predetermined time period or longer, from among the pieces of stored information regarding the external apparatuses.

8. The information processing apparatus according to claim 1, wherein the display control unit further causes the display unit to display, on the selection screen, a setting screen for setting a job, and, based on a setting determined via the setting screen, to display the external apparatus that supports the setting.

9. The information processing apparatus according to claim 1, wherein the display control unit causes the display unit to display, on the selection screen, the external apparatuses in short-distance order of the distance from the information processing apparatus.

10. The information processing apparatus according to claim 1, further comprising a second specifying unit configured to specify an approach amount indicating a distance at which the information processing apparatus approaches the external apparatus that is a transmission source of the received signal based on a difference between a first distance specified by the specifying unit and a second distance specified by the specifying unit,
wherein the display control unit causes the display unit to display, on the selection screen, the plurality of external apparatuses in descending order of the approach amount.

11. The information processing apparatus according to claim 1, wherein the signal transmitted from the external apparatus is an advertising signal transmitted according to the BLE standard.

12. The information processing apparatus according to claim 1, wherein the external apparatus is a printing apparatus.

13. A display control method comprising:
receiving a signal transmitted from an external apparatus;
specifying a distance from the external apparatus based on an intensity of the received signal;
displaying a selection screen for selecting the external apparatus based on the received signal; and
transmitting data to the selected external apparatus,
wherein, if signals are received from a plurality of external apparatuses, displaying the selection screen includes displaying the plurality of external apparatuses in order of distance based on the specified distance, and
wherein, if a signal is received from each of a first external apparatus having an error occurring therein and a second external apparatus located farther away from an information processing apparatus than the first external apparatus and having no error occurring therein, displaying the selection screen includes displaying the second external apparatus in priority to the first external apparatus.

14. The method according to claim 13, wherein the second external apparatus is displayed higher than the first external apparatus in a list of the plurality of external apparatuses on the selection screen.

15. The method according to claim 13, wherein a priority assigned to a display of the external apparatus having the error occurring therein is lower than a priority assigned to a display of the external apparatus having no error occurring therein on the selection screen.

16. The method according to claim 13, wherein information regarding the external apparatus based on the received signal is stored,
wherein the stored information regarding the external apparatus is updated when the signal is received, and
wherein a selection of the external apparatus corresponding to the information regarding the external apparatus that has not been updated for a predetermined time period or longer is prohibited, from among pieces of stored information regarding the external apparatuses.

17. The method according to claim 13, wherein the external apparatuses in short-distance order of the distance from the information processing apparatus is displayed on the selection screen.

18. The method to claim 13, wherein the signal transmitted from the external apparatus is an advertising signal transmitted according to the BLE standard.

19. The method according to claim 13, wherein the external apparatus is a printing apparatus.

20. A non-transitory computer-readable recording medium storing computer executable instructions for causing a computer to execute a method, a method comprising:
receiving a signal transmitted from an external apparatus;
specifying a distance from the external apparatus based on an intensity of the received signal;
displaying a selection screen for selecting the external apparatus based on the received signal; and
transmitting data to the selected external apparatus,
wherein, if signals are received from a plurality of external apparatuses, the display control includes displaying the plurality of external apparatuses in order of distance based on the specified distance, and
wherein, if a signal is received from each of a first external apparatus having an error occurring therein and a second external apparatus located farther away from an information processing apparatus than the first external apparatus and having no error occurring therein, displaying the selection screen includes displaying the second external apparatus in priority to the first external apparatus.
